(19) United States
(12) Patent Application Publication
(10) Pub. No.: US 2005/0223064 A1
(43) Pub. Date: Oct. 6, 2005

(54) Method and system for electronic message retraction

(76) Inventors: Robert Salerno, Woodbridge (CA); Bruce Grant, Mississauga (CA)

Correspondence Address: WILLIAM B. PATTERSON;MOSER, PATTERSON & SHERIDAN, L.L.P., Suite 1500, 3040 Post Oak Blvd., Houston, TX, 77056, US

(21) Appl. No.: 10/816,135

(22) Filed: Apr. 1, 2004

(51) Int. Cl. G06F 15/16; G06F 15/173

(52) U.S. Cl. 709/206; 709/223

(57) ABSTRACT

A system and method for retracting an electronic mail document stored in a mail database of a Server sent from a sender to a recipient. A fetch monitor at the Server monitors activity on the mail document and marks the status of the mail document accordingly. A fetch control issues a request to retract the mail document to a fetch queue at the Server. The request is retrieved by a fetcher at the Server from the fetch queue, which then proceeds to retract the mail document based on the marked status of the mail document, and then reports the retraction.

### TECHNICAL FIELD OF THE INVENTION

This invention is related to the field of electronic messaging, more specifically to the management of electronic messages.

### BACKGROUND OF THE INVENTION

In personal and business environments, electronic mail messaging (email) has become a ubiquitous and essential tool for keeping contact with persons and disseminating information across space. Such email systems as Lotus Notes, Novell Groupwise, and Microsoft Exchange have provided ease of use and rapid speed of transmission. These latter advantages are important factors for its rapid adoption by the modern day office and person.

The same factors also contribute to reasons why its users have come to regard email as a medium of correspondence to be used with great care. As with other electronic tools, accuracy becomes essential: mistakes are seldom tolerated easily. As a result, a defective email message may be sent and escapes beyond the control of the sender in the inadvertent press of a single key. These defects may include an incorrect recipient address, missing recipient address (e.g. carbon-copy or blind-carbon-copy), incorrect or missing message content, unintended tone of message content, and incorrect or missing attachment. Additionally, malicious and damaging emails can be easily distributed to broad audiences intentionally (e.g., in the case of a disgruntled employee) or unintentionally (e.g., in the case of a virus).

In each of the above cases, there is a need to be able to retract the defective email message.

Typically, an email system has a Client-Server architecture. For example, Lotus Notes is a Client application which is connected to a Domino email Server component. Users of the email system tap into the system via Lotus Notes; each Notes Client is connected to a Domino Mail Server. A Server is software implemented and multiple Servers can reside in a single physical computer (server). In alternative configurations, the Client may be a Web browser, or another Client application such as Microsoft Outlook, Eudora, or even a mobile device's application.

Email retraction may be implemented in a number of ways. One way is to develop an application to run independently and to make calls into the email Server whenever necessary. The application is truly independent since the Server doesn't really know that the application exists. The Server, such as Domino, usually perceives such an application as users attempting to do document modifications through it.

Such standalone applications run outside the control of the mail Server (e.g. Domino) and must be installed and started independently of the mail server. These would run outside of the server memory space and would not be setup at the same time as the server program requiring separate management and setup.

An application may be alternatively developed as an application extending the mailbox design (known for Lotus systems as template) for allowing the user to make selections (as with Lotus Notes). Requests are sent as email requests to the intended recipient. An agent in the altered mailbox design will run as soon as a mail message is received. The agent will differentiate between true email and retraction requests and perform the required retraction. This relies on changing the email template as well as the server's native method of tracking read/unread documents. The software product known as deMailer (http://www.demailer.com) is one which adopts this approach in the case of Lotus Notes and Domino.

Applications that alter the email template have a low probability of retracting emails successfully based on built-in read/unread documents. Too many false positives can occur. Template changes make upgrading Domino difficult since users have to wait until the template is also updated by the vendor.

This method also does not treat mobile devices or offline email users properly since it retracts email even though the message has already been passed on to the user offline.

An application may be alternatively developed to run on the Client. This is something typically called a hook in Lotus running as part of the Notes Client API. The Client application would typically check to see if there is a hook that has to do some processing (pre or post) and would allow it to perform the activity. One example of this is a commercially available software product called Teamstudio CIAO! For the Lotus Notes system. CAIO! provides library management functions (i.e. Check In/Check Out of items). Since Notes doesn't provide this function CIAO! provides it by intercepting Design Save requests within Notes and checking to see if the database or design element in question is being monitored by the library manager.

Hook applications are Client driven and are burdened by the fact that they have to be distributed, installed and updated on every participating workstation/client as time goes by.

This invention addresses all of these disadvantages.

### SUMMARY OF THE INVENTION

The invention provides a system for the automated monitoring and retraction of electronic mail documents stored in a mail database of a first Server sent from a sender to a recipient comprising: a fetch monitor at the first Server for monitoring activity on the mail document and marking the status of the mail document; a fetch control for issuing a request to retract the mail document to a fetch queue at the first Server; and a fetcher at the first Server for retrieving the request from the fetch queue, retracting the mail document based on the marked status of the mail document, and reporting the retraction.

This invention also provides a method for retracting an electronic mail document stored in a mail database of a first Server sent from a sender to a recipient comprising the steps of: monitoring activity on the mail document and marking the status of the mail document using a fetch monitor; issuing a request to retract the mail document to a fetch queue at the first Server; retrieving the request from the fetch queue by a fetcher at the first Server; retracting the mail document based on the marked status of the mail document by the fetcher; and reporting the retraction.

### BRIEF DESCRIPTION OF THE DRAWINGS

FIG. 1 is a block diagram of one embodiment of the invention;

FIG. 2 is a flow diagram of one embodiment of the invention;

FIG. 3 is a block diagram of a single cluster configuration of this invention;

FIG. 4 is a block diagram of a multi-cluster configuration of this invention; and

FIG. 5 is a block diagram of a multi-domain configuration of this invention.

### DETAILED DESCRIPTION OF THE INVENTION

The discussion below uses Lotus Notes and Domino as examples; it will be clear to a person skilled in the art how the invention may be implemented for any general email system with the same operating environment(s) and constraints indicated below. A description of the Lotus systems may be found at http://www-10.lotus.com/ldd/notesua.nsf/White%20Papers?OpenView and http://www-12.lotus.com/ldd/doc/domino_notes/Rnext/help6_admin.nsf/(Help)/glossary, the contents of which papers and pages are incorporated herein by reference.

In this document, the term Server is used to denote an email server, unless otherwise qualified (e.g. application server, physical server). A Server is implemented at the application level; more than one Server may reside at the same physical server. One example of a Server is a Domino mail server.

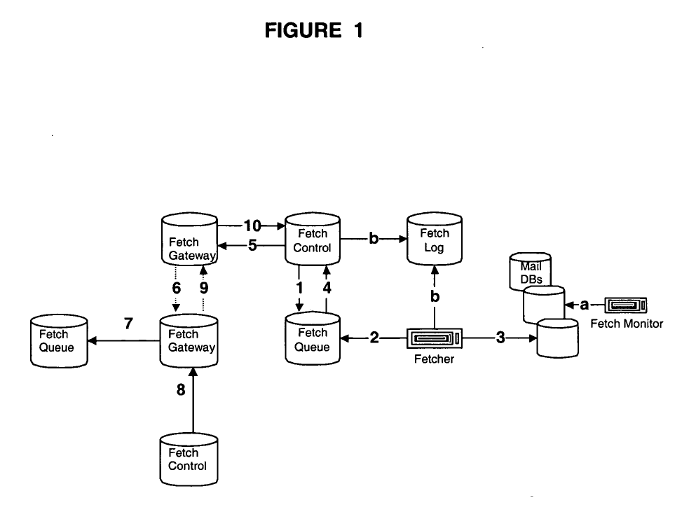

A block diagram configuration of the server 20 (not shown) of an electronic messaging system incorporating elements of one embodiment of the invention is illustrated in FIG. 1. As mentioned earlier, the Client program (not shown) communicating with the server may be one of a variety of e-mail client programs, such as Microsoft Outlook Express, Lotus Notes, Eudora, Browser email client, and the like. Additionally, the Client program may also be a web-based e-mail environment, such as YAHOO.COM and HOTMAIL.COM.

The components are shown as separate entities in FIG. 1 for illustrative purposes. However, these components may reside in the same software subsystem (e.g. Domino extension manager & server task). For convenience, the email retraction system of embodiments of this invention is denoted in this document as Fetch.

FIG. 1 shows a configuration for single server in a single domain configuration (a Fetch gateway 40 is shown for connection to other domains along with the Fetch queue 60 and Fetch control 30 of the other domain) and the date flow for the retraction system (discussed below). A domain for the purpose of one instance of Fetch is defined in this document as consisting of the Servers 20 and Clients in a network whose users, servers, connections, and access control information it knows about, has the authority to control and in a logically accessible location (e.g. not behind a firewall). An external domain to an instance of Fetch typically means it's out of its sphere of control of and/or in a logically inaccessible area; therefore, it has to communicate through gateways 40 in its own domain and the other domain using preferably SMTP mail to route requests between the gateways. So depending upon how mail gets routed then it could possibly go through one or more domains.

Combined with other Server-related technology (e.g. database, formula, and Lotus script for the Domino environment), there are two core components to Fetch, which are denoted in this document as Fetcher 50 and Fetch Monitor 80. Other ancillary support components are described hereafter. A database in this document relates to an entity which may include data, related tasks, agents, and programmes.

Fetcher 50 is a server add-in task for accessing any user's mailbox in the database 70. It runs at a privilege level enabling it able to access any user's mailbox and take proper action without changing the user mailbox design and current security setting (in the Domino environment, this is typically server's privilege).

A server add-in task is basically a task that runs in the Server 20 at the server level (e.g. a Domino server add-in task). It makes special use of the Server's API to allow the system to treat this as a server task (e.g. indexer, replicator, router, in the Domino environment). Built optionally with Java technology, Fetcher 50 may be platform-independent and multi-threaded. Fetcher 50 monitors the Fetch queue database 60 (discussed later) for new coming Fetch requests, processes Fetch requests if available, and fetches requested mails from recipients' mailboxes in the electronic mail database 70, and sends back Fetch reports.

As a server extension manager, Fetch Monitor 80 typically runs at the same privilege as the Fetcher 50. What Fetch monitor 80 does is to monitor users' mailboxes in the electronic mail database 70 at the server 20 where the Fetch monitor 80 is resident, and keep track of users' activities on the mailboxes, including read, preview, copy, replication etc., on electronic mail messages in these mailboxes by setting flags (possibly in the accessed mail documents). In particular, the Fetch monitor 80 keeps a record of whether email messages have been read by their recipients. The preferable states to be monitored are: “Accessed”, “Read”, and “Unread”.

This removes the need to rely on the unread/read mark system of the Server 20 (e.g. the Domino unread/read mark system), which is typically rudimentary and defines narrowly “read” status. For example, the current Domino system has the following characteristics as to read vs. unread marks:
(1) The read/unread status can be changed by the recipient;
(2) A user can read a document through preview mode without affecting the read/unread marks;
(3) A user can read his mail through HTTP without affecting read/unread marks; and
(4) A user can replicate his mail without replicating his read/unread marks. [So the mark for the new mail document is unread ? the mark is unknown since it's not copied during replication]

In another example, a person who takes their mail offline has accessed his or her mail. In each of the above cases, preferred embodiments of this invention would have Fetch Monitor 80 indicate the mail document as “Accessed” and not leave it as “Unread”.

A server extension manager runs as part of the API of the Server 20. One example of this is a Domino extension manager. A Server 20 would typically intercept Document requests (open, edit, save, close, etc.). As any of these activities occur its related extension manager(s) is called. Uses for extension manager include real-time virus scanning of email and monitoring of performance. Fetch has a process that monitors “mail” document usage independent of the Server. As mentioned earlier, the Fetch Monitor 80 tracks whether a document has been “Read” or “Accessed” and optionally the identity of the process which touched the document. The activities of selected Client processes which touch or access user email are monitored, (e.g., HTTP for reading mail over the internet; an agent Manager for forwarding mail by a user to another account; the Server 20 itself for replicating mail offline, reading or previewing mail, or copying mail somewhere). Some of these activities will register as a user reading a document; others will be registered as a users “accessing” mail, e.g., replicated email that is offline is marked as accessed.

A server extension manager provides a “hook” into the numerous Server 20 processes and the Fetch Monitor 80 process makes use of the extension manager hook. Accessed documents are marked by the Fetch Monitor 80 as read or accessed based on the process that touches a specific email. Delegated email access may also be tracked (e.g., an executive with an Administrative Assistant who reads email on the executives behalf) and treated as if the owner of the email had themselves accessed the email.

Typically (but not always) the processing of “Accessed” mail documents are the same as “Read” documents by Fetcher 50. That is to say, an “Accessed” document is treated as if it has been “Read”. For example, if the system is configured to retract only those mail messages which have not been “Read”, then “Accessed” documents will not be retracted. Using the specific type of “Access” activity, it may be possible to include or exclude certain types of accessed documents from retraction. In preferred embodiments, a generated report states the status of the mail document when the attempt to retract by Fetcher 50 in the same domain (or one in an external domain) took place.

Fetcher 50 works with the support of a number of a number of other components. The other components are as follows.

Fetch control 30 (preferably a database, a server application software or a subcomponent thereof) is the user and administration interfaces of Fetch, and is also typically the central place to hold the Fetch requests, reports and statistics.

Fetch gateway 40 (preferably a database, a server application software or a subcomponent thereof) processes any out-going Fetch requests/reports to other domains and in-coming Fetch requests/reports from other domains.

Fetch queue 60 (preferably a database, a stack, a server application software or a subcomponent thereof) is the place to hold all Fetch requests/reports for the Server 20 where the current Fetch queue 60 resides and is monitored by the Fetcher server task 50.

Fetch log 90 (preferably a database, a file, a server application software or a subcomponent thereof) holds all Fetch events/error messages/warning messages/debug messages for Fetch queue 60 and Fetcher server task 50 on the Server 20 where the current Fetch log 90 is located.

The following show how these two core components may work with other Fetch components mentioned above, as indicated in FIG. 1.
1: An email retract request is submitted by Fetch Control 20 to the Fetch queue 60. This request typically arises from a sender of an email message using a Client.
2: Fetcher 50, which is constantly monitoring the Fetch queue database 60, retrieves the request and processes it;
3: Fetcher 50 goes to the user's mailbox in the Electronic mail database 140 to get the requested mail based on the information provided in the request;
4: Based on the result of step 4, a Fetch report is sent back to Fetch Control 20 by way of the Fetch queue 60;
5: A Fetch request is sent to a Fetch gateway 40 for retrieving a mail from another Domain;
6: The Fetch request (or a variant thereof) is delivered by the Fetch gateway 40 to a Fetch gateway 40 in another Domain;
7: The Fetch request is forwarded by the Fetch gateway 40 in the other Domain to its Fetch queue 60;
8: A Fetch report is sent to the Fetch gateway 40 of the other Domain from its Fetch control 30. A user has the option of requesting an immediate report of the status of the retraction request. Otherwise, a periodic report is generated (possibly by the Fetch queue 60 of the recipient domain) and sent back to Fetch Control 30.
9: The Fetch report is forwarded to the local Fetch gateway 40 from the Fetch gateway 40 of the other Domain;
10: The Fetch report is further passed back to the Fetch control 30 from the local Fetch gateway 40;
a: The Fetch monitor 80 keeps monitoring the user's mailbox all the time and records the user's activity on it; and
b: All events are logged into the Fetch log database 90.

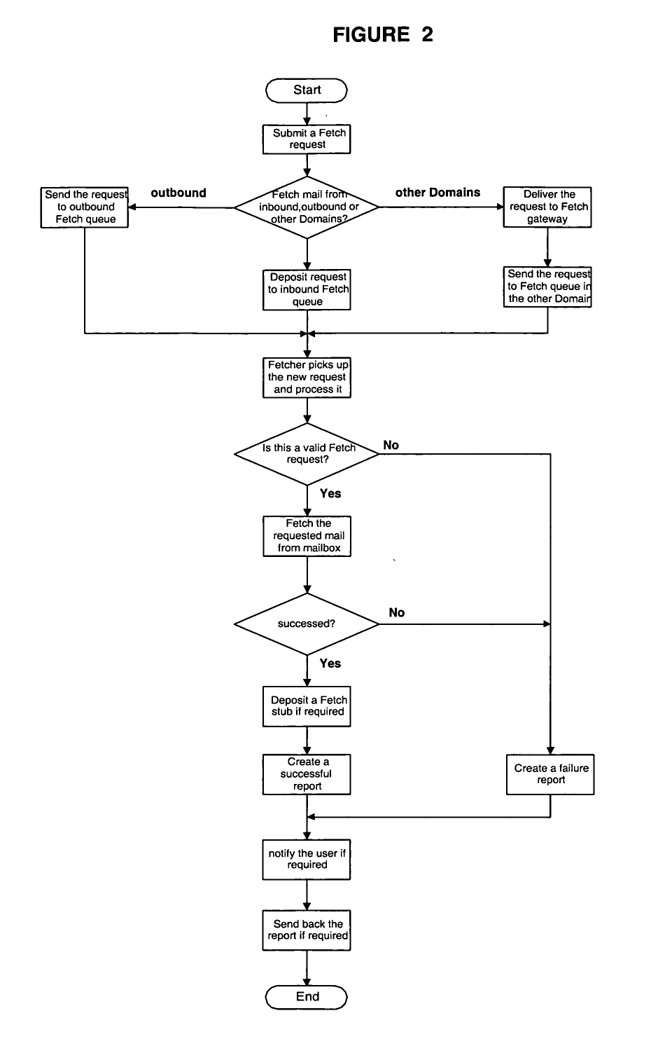

A flow diagram for a variant of elements 1 to 5 above is shown in FIG. 2.

An option which is shown in FIG. 2 is to leave a document or message in place once the mail is retrieved. Fetch may be configured for the circumstances when one such document is to be left. The actual content of the message can be varied.

In one possible embodiment of the invention, there is no Fetch monitor 80 in a Retraction implementation. As a result, it will not be possible for the Retraction system to determine whether a mail message has been read. A Client (user) will be allowed to retract mail whether it has been read or not, provided that it has not been deleted from the system. Alternatively, the email system may be set up so that only an administrator may be permitted to retract mail and all users must funnel their request for retraction through the administrator.

Fetch can be configured to retract any one or a combination of “Unread”, “Read” or “Accessed” mail. Typically, an administrator has the option to override this on his own requests. Even if the system is configured to allow the retraction of “Read” mail, one may still wish to know whether the mail document was read or not so that damage control for those people who have read it may be performed.

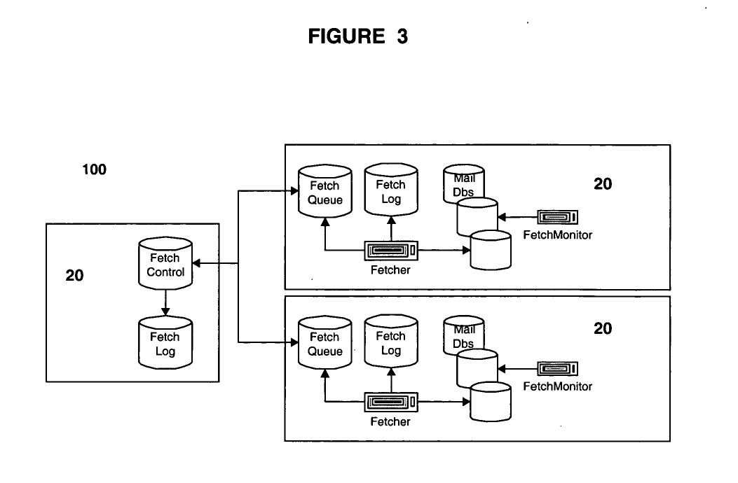

A possible configuration where more than one cluster 100 forms a single domain is illustrated in FIG. 3. A cluster 100 is a group of two or more Servers 20 in the same domain, typically set up to provide users with constant access to data, and balance the workload among Servers. Each cluster 100 would preferably have a single instance of Fetch control 30.

FIG. 3 shows a single cluster 100 with 3 separate Servers 20, where 2 servers 20 are “mail” Servers 20, each with its mail databases 70 and associated Fetch monitor 80 and Fetcher 80. The other Server 20 is an “application” server 20, which hosts the single instance of Fetch Control 30 in the cluster 100 and an optional Fetch log 90. Fetch control 30 monitors and issues retraction requests to the Fetch queues 60 of both mail servers 20 but sends reports to its own Fetch log 90. Fetcher 50 at each Server 20 performs the functions set out earlier discussed for FIG. 1. Although not shown in FIG. 3, the “application” Server 20 typically has its own Fetcher 50, Fetch queue 60, Fetch log 90, Fetch monitor 80, and email database 70 for local mail retraction.

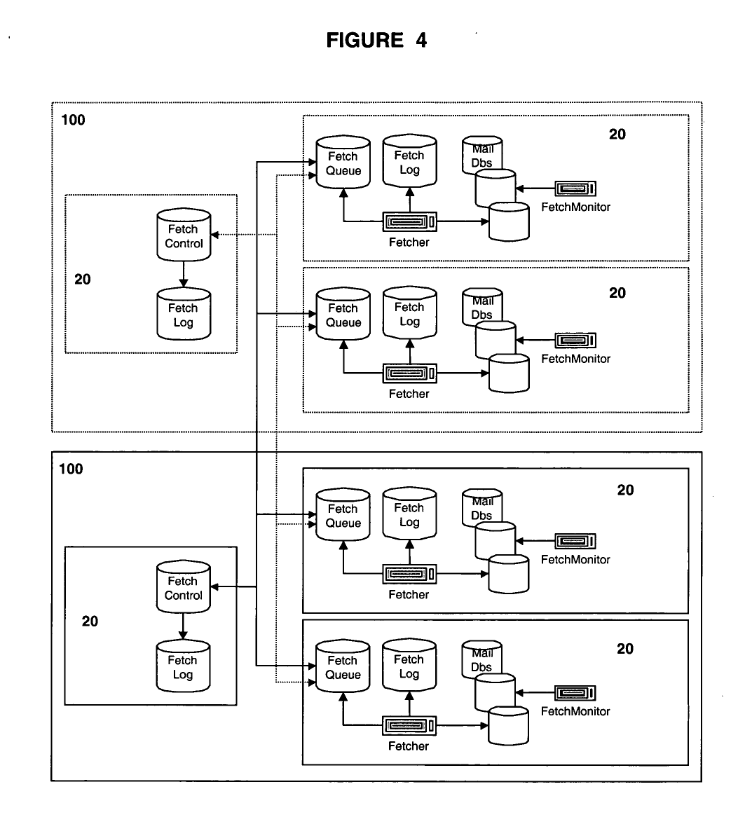

In a further embodiment shown in FIG. 4, multiple clusters 100 of a single domain may be accommodated as shown in FIG. 4. Fetch control 30 in each cluster communicates with the Fetch queue 60 of every “mail” server 20 of all the other clusters 100.

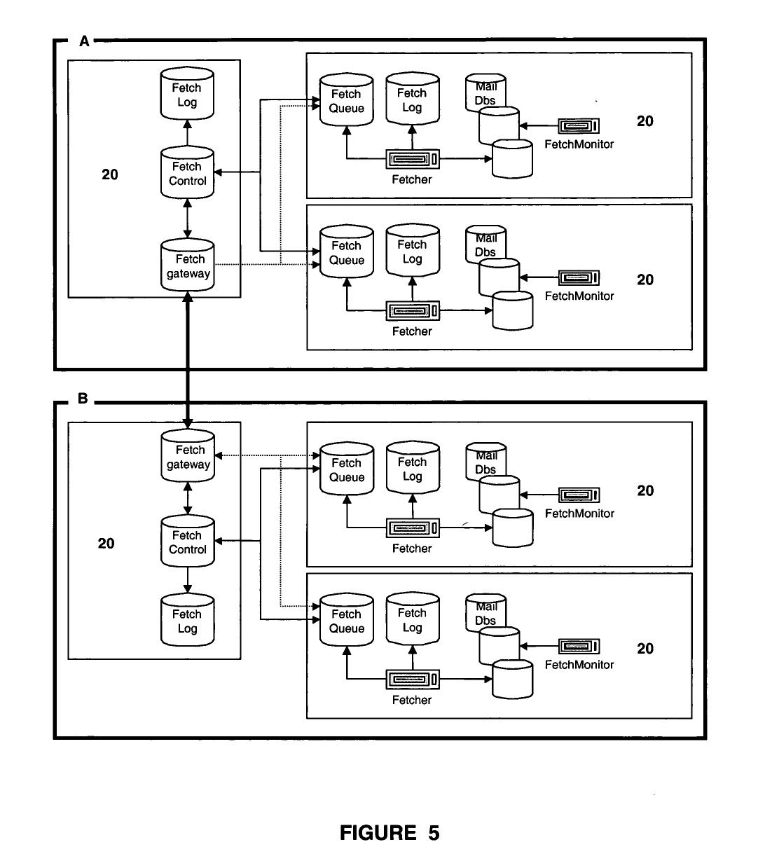

FIG. 5 illustrates a configuration with 2 domains A and B. fetch gateways in each domain perform the functions set out earlier as discussed for FIG. 1. The only variation shown here concerns the variation where Fetch gateways 40 may communicate directly with Fetch queues 60 in their own domain. This is to provide for circumstances where Fetch queue 60 may have logic to prepare periodic reports independent of Fetch control 30.

In further embodiments, Fetch has one or more in combination of the following characteristics:
(1) retract mail messages irrespective of the source of the email;
(2) retract (with or without administrator override) email of a certain age;
(3) retract mail messages from email servers for mobile devices (e.g. systems known as Blackberry);
(4) retract mail from mail servers for offline email;
(5) retract mail documents using multi-lingual interface and responses;
(6) a trust mechanism whereby domains recognize each other electronically; and
(7) a web interface for issuing retraction requests.

Security

To protect Fetch from being abused, security may be part of the system architecture.

Fetch security is designed to keep unauthorized users from accessing Fetch, prevent authorized users from abusing Fetch and protect Fetch from manipulated fake requests.

Fetch security consists of several layers—once a user passes through one security layer, the next layer of security is enforced. One or more layers are typically used for embodiments of this invention. The following includes a brief description of the security layers that protects the Fetch system.
(1) The Fetch user must be a valid Client user who has been registered in a directory;
(2) The Fetch user must have at least a certain specified of access to the Fetch databases (e.g. Author level for Domino);
(3) To Fetch mail on behalf of another user, a user must have been assigned a Proxy role and have sufficient access privilege, which is configurable in the Fetch setting, to the other user's mailbox;
(4) To modify Fetch setting and do other Fetch administration tasks, the user must have been assigned an Administrator role;
(5) Each submitted Fetch request is signed by the submitter;
(6) Before processing a Fetch request, Fetcher server task checks the request's signer, author, submitter (who physically submits the request; this could be Fetch proxy), request user (whom the request is submitted for), submitter's group and role, makes sure the request is safe to be processed;
(7) An out-of-Domain Fetch request is allowed to be submitted to trusted Domain only; and
(8) A Fetch security code is inserted into each out-of-Domain Fetch request to prevent request from being manipulated before reaching the destination Domain.

It will be appreciated that the above description relates to the preferred embodiments by way of example only. Many variations on the system and method for delivering the invention will be clear to those knowledgeable in the field, and such variations are within the scope of the invention as described and claimed, whether or not expressly described.

1. A system for retracting an electronic mail document stored in a mail database of a first Server sent from a sender to a recipient comprising:
a fetch monitor at the first Server for monitoring activity on the mail document and marking the status of the mail document;
a fetch control for issuing a request to retract the mail document to a fetch queue at the first Server; and
a fetcher at the first Server for retrieving the request from the fetch queue, retracting the mail document based on the marked status of the mail document, and reporting the retraction.

2. The system of claim 1, wherein:
the fetcher reports the retraction by sending a retraction report to the fetch queue; and
the fetch control retrieves the retraction report from the fetch queue.

3. The system of claim 1 further comprising a fetch log at the first Server for receiving an event report from the fetcher.

4. The system of claim 1, wherein the fetch control is at the first Server.

5. The system of claim 1, wherein the fetch control is at a second Server in the same cluster as the first Server.

6. The system of claim 1, wherein the fetch control is at a second Server in a different cluster as the first Server.

7. The system of claim 1 further comprising:
a first gateway and a destination fetch control at a first domain, the first domain being the same domain as the first server;
a second gateway at the same Server as and in electronic communication with the fetch control at a second domain;
wherein the a request to retract the mail document is passed from the fetch control to the fetch queue through the first gateway, the second gateway, and the second fetch control.

8. The system of claim 1, wherein the fetch monitor is a Domino extension manager.

9. The system of claim 1, wherein the fetcher is a Domino server add-in task.

10. The system of claim 1, wherein:
the Server has its own means for marking the status of the mail document and the status is changeable by the recipient;
the user can read the mail document through preview mode without affecting the status;
the user can read the mail document through HTTP without affecting the status; or
the user can replicate the mail document without replicating the status.

11. A method for retracting an electronic mail document stored in a mail database of a first Server sent from a sender to a recipient comprising the steps of:
monitoring activity on the mail document and marking the status of the mail document using a fetch monitor;
issuing a request to retract the mail document to a fetch queue at the first Server;
retrieving the request from the fetch queue by a fetcher at the first Server;
retracting the mail document based on the marked status of the mail document by the fetcher; and
reporting the retraction.
